(19) United States
(12) Patent Application Publication
(10) Pub. No.: US 2026/0346605 A1
(43) Pub. Date: Nov. 5, 2026

(54) LIQUID EJECTION HEAD SUBSTRATE AND METHOD FOR MANUFACTURING LIQUID EJECTION HEAD SUBSTRATE

(71) Applicant: CANON KABUSHIKI KAISHA, Tokyo (JP)

(72) Inventors: MAKOTO TAGUCHI, Kanagawa (JP); MICHIKO JOHNSON, Tokyo (JP); TAMAKI SATO, Kanagawa (JP); AYAKO MARUYAMA, Kanagawa (JP)

(21) Appl. No.: 19/662,460

(22) Filed: Apr. 29, 2026

(30) Foreign Application Priority Data
May 1, 2025 (JP) 2025-076387

(51) Int. Cl. B41J 2/14; B41J 2/16

(52) U.S. Cl. CPC B41J 2/14233; B41J 2/161; B41J 2/1623; B41J 2002/14306

(57) ABSTRACT

A liquid ejection head substrate comprises a base substrate, in which a liquid feeding port penetrates therethrough in a first direction and in which a damper chamber is provided on a bonding surface so as to be depressed in the first direction, and to which a flexible member is bonded so as not to block the liquid feeding port and so as to block the damper chamber, and a flow passage substrate which has a flow passage forming portion that communicates with the liquid feeding port, and which is stacked in the first direction relative to the base substrate via the flexible member. The base substrate has a depressed portion provided in the bonding surface so as to be depressed in the first direction, the depressed portion being at a position not overlapping the liquid flow passage when viewed in the first direction, and blocked by the flexible member.

### BACKGROUND

### Field of the Technology

The present disclosure relates to a liquid ejection head substrate and a method for manufacturing the same.

### Description of the Related Art

A liquid ejection head that generates pressure fluctuations in a pressure generation chamber filled with liquid, and that ejects liquid from a nozzle is known. In such a liquid ejection head, a head configuration is known in which a unit member for suppressing pressure fluctuations, i.e., called a damper, is disposed in the liquid flow passage for the purpose of preventing pressure fluctuations from propagating to another adjacent pressure generation chamber, thereby deteriorating the controllability of ejection. Japanese Patent Application Publication No. 2018-154085 discloses a configuration in which the size of a liquid ejection head is reduced by three dimensionally arranging a common liquid chamber and a damper chamber.

When the damper is configured by joining a flexible member to a substrate, it is necessary to perform a heat treatment during the joining. During the heat treatment, the flexible member may be deflected toward the inside of the damper chamber (depressed portion) formed on the junction surface of the flexible member in the substrate due to the difference in thermal expansion coefficient between the flexible member and the substrate. In the case where junction with the flow passage substrate is achieved in this state, the deformation amount of the flexible member is limited when pressure fluctuation occurs. For this reason, the fluctuation suppressing effect is lowered, and the damping performance is not sufficiently exhibited, hence the liquid ejection performance may be deteriorated.

### SUMMARY

The present disclosure is directed to provide a technique capable of stabilizing the liquid ejection performance of a liquid ejection head.

According to some embodiments, liquid ejection head substrate of the present disclosure is characterized by features including:
a pressure chamber provided with an ejection port for ejecting liquid;
a pressure generation unit configured to generate a pressure inside of the pressure chamber to eject liquid from the ejection port;
a liquid feeding port configured to receive a supply of liquid;
a liquid flow passage configured to guide liquid from the liquid feeding port to the pressure chamber;
a flexible member that constitutes a portion of an inner wall surface of the liquid flow passage; and
a damper chamber forming a space allowing deformation of the flexible member, the space being separated from the liquid flow passage by the flexible member, wherein
the liquid ejection head substrate includes:
a base substrate having the liquid feeding port penetrating in a first direction therethrough, and having the damper chamber provided on a bonding surface that is one surface in the first direction so as to be depressed in the first direction, and having the flexible member bonded thereto so as not to block the liquid feeding port and so as to block the damper chamber; and
a flow passage substrate having a flow passage forming portion that communicates with the liquid feeding port to form a portion of the liquid flow passage, the flow passage substrate being stacked relative to the base substrate via the flexible member in the first direction,
the base substrate having a depressed portion provided so as to be depressed in the first direction at the bonding surface, and the depressed portion being at a position not overlapping the liquid flow passage as viewed in the first direction, and being blocked by the flexible member.
According to some embodiments, a method for manufacturing a liquid ejection head substrate, the liquid ejection head substrate including:
a pressure chamber provided with an ejection port for ejecting liquid; a pressure generation unit configured to generate a pressure inside of the pressure chamber to eject liquid from the ejection port;
a liquid feeding port configured to receive a supply of liquid;
a liquid flow passage configured to guide liquid from the liquid feeding port to the pressure chamber;
a flexible member that constitutes a portion of an inner wall surface of the liquid flow passage; a damper chamber forming a space allowing deformation of the flexible member, the space being separated from the liquid flow passage by the flexible member;
a base substrate having the liquid feeding port penetrating in a first direction therethrough, and having the damper chamber provided on a bonding surface that is one surface in the first direction so as to be depressed in the first direction, and having the flexible member bonded thereto so as not to block the liquid feeding port and so as to block the damper chamber; and
a flow passage substrate having a flow passage forming portion that communicates with the liquid feeding port to form a portion of the liquid flow passage, the flow passage substrate being stacked relative to the base substrate via the flexible member in the first direction, the method for manufacturing the liquid ejection head substrate of the present disclosure is characterized by features including: forming a depressed portion that is depressed in the first direction at a position not overlapping the liquid flow passage as viewed in the first direction and blocked by the flexible member in the bonding surface of the base substrate;
bonding the flexible member to the base substrate;
joining the flow passage substrate and the base substrate such that the damper chamber and the depressed portion are separated from each other by the flexible member; and
curing the flexible member by a heat treatment, wherein
by the heat treatment, the flexible member is deflected such that a portion of the flexible member extends into an inside of the depressed portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross sectional view of a liquid ejection head substrate.

FIG. 2 is an exploded perspective view of a liquid ejection head substrate.

FIGS. 3A to 3D are illustrative diagrams of a method for manufacturing a compliance substrate according to a conventional configuration.

FIGS. 4A to 4E are explanatory diagrams of a method for manufacturing a compliance substrate according to a first embodiment.

FIGS. 5A to 5E are each a cross sectional schematic view of a compliance substrate according to a second embodiment.

FIG. 6 is a cross sectional schematic view of a compliance substrate according to a third embodiment.

FIGS. 7A and 7B are a plan view and a cross sectional schematic view of a compliance substrate according to a fourth embodiment, respectively.

FIGS. 8A to 8D are plan views and cross sectional schematic views of a compliance substrate according to a fifth embodiment.

FIGS. 9A and 9B are each a cross sectional schematic view of a compliance substrate according to a sixth embodiment.

FIG. 10 is a cross sectional schematic view of a compliance substrate according to a seventh embodiment.

FIG. 11 is a schematic cross sectional view of a liquid ejection head substrate according to Example 1.

FIG. 12 is a schematic cross sectional view of a liquid ejection head substrate according to a conventional configuration.

### DESCRIPTION OF THE EMBODIMENTS

Hereinafter, aspects for carrying out the present disclosure will be described exemplarily in detail on the basis of Examples with reference to the drawings. However, the dimensions, materials, shapes, relative arrangements, and the like of the constituent components described in the present embodiment should be appropriately changed according to the configurations and various conditions of apparatuses to which the present disclosure is applied. That is, the scope of the present disclosure is not intended to be limited to the embodiments described below.

A liquid ejection head according to an embodiment of the present disclosure is provided as a constituent element for ejecting liquid in a recording apparatus as a liquid ejection apparatus for ejecting liquid on a recording material to record characters, figures(images), and the like. A recording liquid is typically an ink, and may also include, for example, a liquid that is subjected to the treatment of the ink (e.g., coagulation or insolubilization of colorants in an ink that is applied to a recording material). The recording is not limited to the case where a significant information such as a character or a figure is formed, and whether the information is significant or insignificant does not matter. Moreover, regardless of whether the result is manifested in a form visually perceptible to the human eye, the recording may broadly include the operation that forms images, designs, patterns, or the like on a recording material, or that performs processing of a recording material. The recording apparatus is typically an ink jet printer, and may also include an apparatus in which processing other than formation of characters, figures, etc., is performed by ejecting liquid onto a recording material as described above. Also, the recording materials are typically paper, and may include the articles capable of receiving an ink such as cloth, a plastic film, a metal plate, glass, ceramics, wood, and leather.

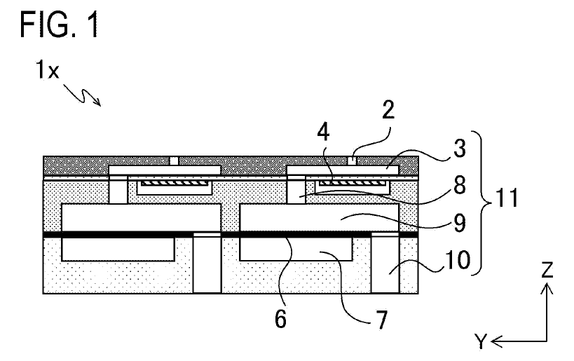

With reference to FIG. 1, the configuration of a conventional general liquid ejection head substrate and the manufacturing method thereof will be described as a comparative example of the present embodiment. FIG. 1 is a schematic cross sectional diagram of a liquid ejection head substrate 1x according to Comparative Example. In general, the liquid ejection head substrate is a substrate constituting a part of a liquid ejection head, and mainly playing a function of distributing the liquid supplied from the outside to respective individual nozzles, and ejecting the liquid from a plurality of nozzles. The substrates for a liquid ejection head 1 and 1x of the present embodiment and Comparative Example each have a nozzle 2 for ejecting liquid, and a liquid flow passage 11 connected to the nozzle 2. FIG. 1 shows a cross section of a region in which two nozzles 2 are arranged as the cross section of the liquid ejection head substrate 1x of Comparative Example. That is, the liquid ejection head substrate 1x is further provided with a plurality of nozzles 2 as shown in FIG. 1.

Herein, in each drawing of FIGS. 1 and subsequent drawings, the X direction represents the direction in which the ejection ports of the nozzle 2 are opened, and is typically in agreement with the vertical direction in the case of assembly in the recording apparatus. The Y direction and the Z direction are directions orthogonal to each other, and directions orthogonal to the X direction, respectively. The plurality of nozzles 2 are typically arranged in an array in each of the Y direction and the Z direction.

A liquid flow passage 11 includes elements such as a pressure chamber 3 provided with a pressure generation unit 4, individual feeding ports 8, a common flow passage 9, and a liquid feeding port 10. The positions of arrangement, the dimensions, the paths, or the like can assume various configurations depending on the manufacturing method and the ejection performance to be desired. For example, it is also possible to provide such a liquid flow passage that the liquid supplied from the outside of the liquid ejection head substrate 1x is transported to the vicinity of the nozzle and the liquid not ejected returns to the outside again. A flexible member 6 for suppressing pressure fluctuations is formed at a midpoint of the liquid flow passage 11 together with the adjacent space 7 (damper chamber).

As the pressure generation unit 4, for example, a diaphragm including piezoelectric elements stacked therein, a heating resistor, or the like can be used. The pressure generation unit 4 is formed in the pressure chamber 3, and generates a pressure to eject liquid such as an ink from the nozzle 2. The individual feeding ports 8 are connected to the pressure chambers 3 which are individually controlled. It may be configured such that a plurality of individual feeding ports 8 are connected to one pressure chamber 3. Alternatively, it may be configured such that, conversely, one individual feeding port 8 is connected to a plurality of pressure chambers 3. A common flow passage 9 is connected with the plurality of individual feeding ports 8 and acts as a reservoir for distributing liquid.

The flexible member 6 is provided at a midpoint of the liquid flow passage 11, and is formed so as to serve as a part of the side wall (inner wall surface) of the liquid flow passage 11, and to be in contact with liquid. The flexible member 6 is adjacent to a space 7 which serves as a space for displacement thereof, and no liquid flows thereinto. The portion of the flexible member 6 other than the fixed portion is deflected in response to the pressure fluctuation occurring in the pressure chamber 3. The flexible member 6 is a member for absorbing pressure fluctuations occurring in the pressure chamber 3 by its flexibility, and suppressing the pressure propagation to the neighboring pressure chamber 3 to stabilize the ejection performance. It can also be configured such that an atmosphere communicating port is provided in the space 7 so as to prevent the displacement of the flexible member 6 from being limited when the inside of the space 7 is rendered in a vacuum state.

Although to the flexible member 6, a film of various flexible materials such as an organic film, an inorganic film, or a metal film can be applied, preferably, an organic resin film having both the flexibility and the resistance to liquid such as polyimide is used. The thickness is appropriately set based on a modulus of elasticity, taking into consideration the viscosity and the density of the liquid for suppressing pressure fluctuations, the ejection frequency of liquid, the distance from the pressure chamber 3, and the like, and the formation is performed generally with a thickness in a range from approximately submicrons to several tens of microns in the application of the liquid ejection head substrate 1.

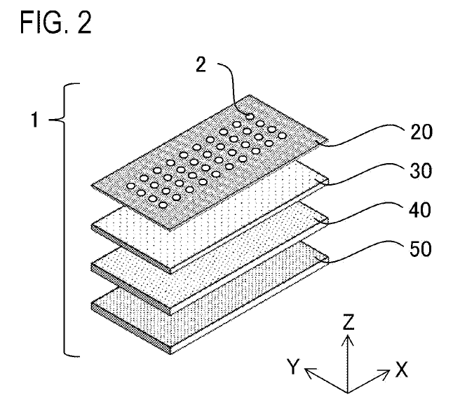

A method for manufacturing a liquid ejection head substrate 1x will be described with reference to FIG. 2. FIG. 2 is an exploded perspective view of a liquid ejection head substrate 1x. As shown in FIG. 2, the liquid ejection head substrate 1x is manufactured by joining a plurality of substrates together. Substrates that make up the liquid ejection head substrate 1x may include, for example, a nozzle substrate 20, a pressure generation substrate 30, a flow passage substrate 40, and a compliance substrate 50.

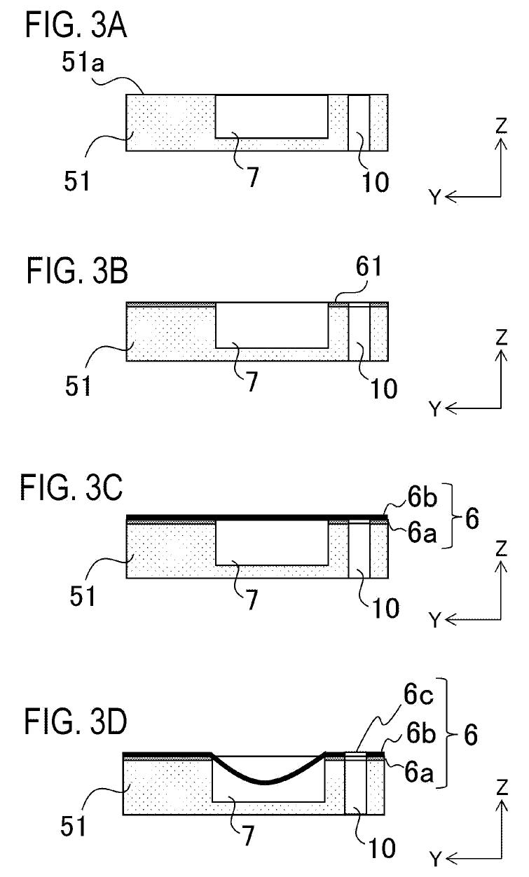

A method for manufacturing the compliance substrate 50 will be described by reference to FIGS. 3A to 3D. FIGS. 3A to 3D, FIGS. 4A to 4E, FIGS. 5A to 5E, FIG. 6, and FIGS. 9A and 9B each show a state in which the compliance substrate 50 is provided with one space 7 and one liquid feeding port 10. FIGS. 1, FIGS. 7A and 7B, FIGS. 8A to 8D, FIGS. 11 and FIG. 12 each show a state in which two spaces 7 and two liquid feeding ports 10 are provided in the compliance substrate 50. However, the number and the size of each constituent element are not limited to those illustrated. The compliance substrate 50 is a composite substrate of a base substrate 51 in which the space 7, the liquid feeding port 10, and the like are processed, and the flexible member 6, and is manufactured by bonding the flexible member 6 to the base substrate 51 serving as a base, followed by fixing.

FIG. 3A shows a state in which a plurality of spaces 7 and liquid feeding ports 10 are formed in the base substrate 51. For example, a silicon substrate is used as the base substrate 51. The space 7 and the liquid feeding port 10 are formed in the base substrate 51 by chemical processing such as etching or a processing method such as laser processing. In other words, the base substrate 51 functions as a flow passage forming member or a space forming member that constitutes the liquid flow passage 11 (the common flow passage 9 and the liquid feeding port 10) and the wall portion of the space 7. The space 7 is formed by perforating a bonding surface 51a of the base substrate 51 to which an adhesive 61 described later is applied. The bonding surface 51a is a fixing surface for fixing the flexible member 6. The liquid feeding port 10 is formed to penetrate from the bonding surface 51a of the base substrate 51 to the opposite surface to the bonding surface 51a.

FIG. 3B shows a state in which the adhesive 61 is applied onto the base substrate 51. The adhesive 61 for fixing the flexible member 6 is applied to the bonding surface 51a of the processed base substrate 51.

FIG. 3C shows the state in which the flexible member 6 is fixed on the base substrate 51. In the following description, a description will be given assuming that the to-be-fixed surface (surface to be bonded) to be fixed to the bonding surface 51a of the base substrate 51 of the flexible member 6 is referred to as a first surface 6a, and that the surface opposite to the first surface 6a is referred to as a second surface 6b. In the state in which the compliance substrate 50 is bonded to the flow passage substrate 40 and the liquid ejection head substrate 1 is completed, the first surface 6a faces the space 7 side, and the second surface 6b faces the common flow passage 9 side (the liquid flow passage 11 side).

After the adhesive 61 is applied to the base substrate 51, next, the film-like flexible member 6 is bonded on the base substrate 51 by roller pressure or the like. Thereafter, a heat treatment (curing) is performed, thereby curing the adhesive 61, so that the flexible member 6 is fixed to the base substrate 51. Although the temperature of the heat treatment varies depending on the material of the adhesive and the heat resistant temperature of the flexible member 6, the polymerization reaction between the adhesive molecules is promoted by heating at, for example, approximately several hundred degrees for curing. Through the step of fixing the flexible member 6, the space 7 becomes a closed space surrounded by the flexible member 6 and the base substrate 51. Further, the opening on the bonding surface 51a side of the liquid feeding port 10 is closed by the flexible member 6.

FIG. 3D shows the state in which an opening portion 6c is formed in the flexible member 6. After the flexible member 6 is fixed on the base substrate 51, the opening portion 6c to serve as a pathway for liquid is formed in the flexible member 6. The opening portion 6c is formed at the position to be connected to the liquid feeding port 10. That is, when viewed in a direction perpendicular to the bonding surface 51a, the opening portion 6c is formed at a position overlapping with the liquid feeding port 10. For example, etching is performed after forming a pattern by a photolithography method, thereby forming the opening portion 6c.

In the thus manufactured compliance substrate 50, there are cases where the flexible member 6 is formed in a deflected state so as to be in a convex shape toward the space 7 side. FIG. 3D shows a state in which the flexible member 6 fixed on the base substrate 51 is deflected. The deflection of the flexible member 6 is caused during curing, and is considered to be caused mainly by the internal stress caused by a microscopic structure or the like of each of the constituent elements and a thermal stress caused by a thermal expansion coefficient of each of the constituent elements. More specifically, a difference in thermal expansion between the flexible member 6 and the base substrate 51 that serves as the underlying layer is considered to be one of the causes. That is, the flexible member 6 and the base substrate 51 are thermally expanded by curing, and one surface of the flexible member 6 is fixed to the base substrate 51 in this state, and then, when cooled, a difference is caused in the amount of contraction between the surface of the flexible member 6 fixed to the base substrate 51 and the surface thereof which is not fixed. Then, a stress is generated in the flexible member 6, and this stress is considered to be one of the causes of generation of the deflection of the flexible member 6.

Further, a difference in thermal expansion between the flexible member 6 and the adhesive 61 is also considered to be one of the causes of generation of the deflection of the flexible member 6. That is, the flexible member 6 and the adhesive 61 are thermally expanded by curing, and in this state, the adhesive 61 causes a curing reaction. This causes a surface to be fixed and a surface not to be fixed on the flexible member by the adhesive 61. In the process of cooling, a difference is caused in the amount of contraction between the fixed surface and the unfixed surface of the flexible member 6. Then, a stress is generated in the flexible member 6, and this stress is considered to be one of the causes of generation of the deflection of the flexible member 6.

In a layered product of different kinds of materials having different thermal expansion coefficients, generally, a stress is generated which causes warping so as to result in a convex shape toward the side of the material having a smaller thermal expansion coefficient. Therefore, for example, when a silicon substrate is used as the base substrate 51 and an organic resin is used as the flexible member 6, in general, the relationship of the thermal expansion coefficient of the flexible member > the thermal expansion coefficient of the silicon substrate holds. In such a case, the flexible member 6 is warped, and deflected so as to be in a convex shape toward the space 7 side. When the liquid ejection head substrate 1 is manufactured with the flexible member 6 deflected, the displacement of the flexible member 6 toward the space 7 side is limited when the pressure fluctuations are absorbed, and the suppression function is also limited. Therefore, in the configuration of the comparative example, when pressure fluctuations occur in the common flow passage 9 in the pressure generation chamber, there is a fear that the pressure fluctuations are propagated to another common flow passage 9 or the like and the controllability of ejection of the liquid ejection head substrate 1 may be deteriorated.

### First Embodiment

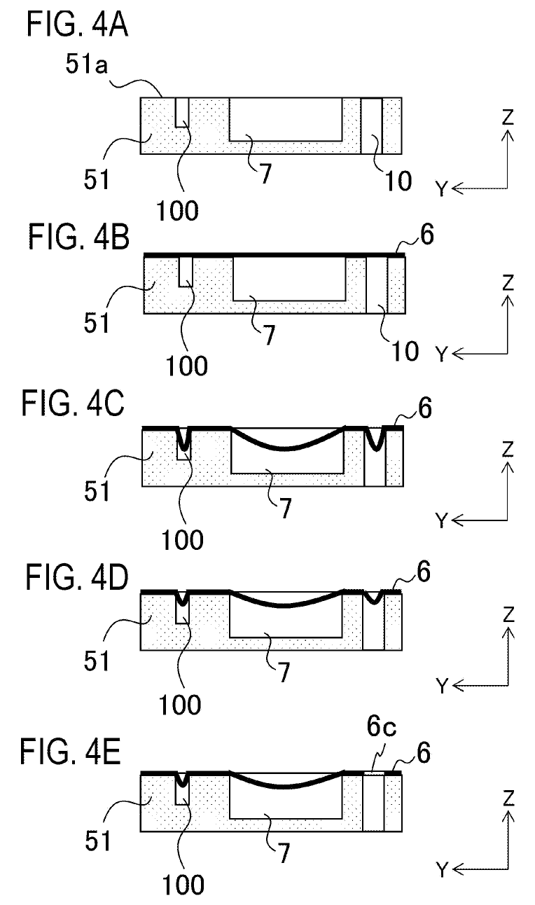

A compliance substrate 50 according to a first embodiment will be explained with reference to FIGS. 4A to 4E. It should be noted that, in the first embodiment, the same reference numerals and signs are assigned for the configurations common to the above-mentioned comparative example, the repeated description thereof will be omitted, and differences from the above-mentioned comparative example will be mainly described. Matters not particularly described in the first embodiment are the same as in the comparative example.

FIGS. 4A to 4E are explanatory diagrams of a manufacturing method of the compliance substrate 50 according to the first embodiment; In the first embodiment, a groove 100 is formed in at least a part of the surface of the base substrate 51 constituting the compliance substrate 50 to which the flexible member 6 is joined, and the flexible member 6 partially extends into the groove 100.

FIG. 4A shows the state in which the groove 100 is formed on the base substrate 51 between the base substrate 51 and the flexible member 6 constituting the compliance substrate 50. FIG. 4B shows the state in which the flexible member 6 is fixed on the base substrate 51. FIG. 4C shows the state in which a heat treatment is performed in order to bond the flexible member 6 and the base substrate 51. FIG. 4D shows a state in which the flexible member 6 and the base substrate 51 are bonded to each other at normal temperature after the completion of the heat treatment. FIG. 4E shows the state in which the opening portion 6c is formed in the flexible member 6. The opening portion 6c is joined to the flow passage substrate 40 later to serve as a liquid flow passage.

In FIG. 4C, the flexible member 6 undergoes deflection so as to be in a convex shape with respect to the space 7 by the heat treatment. The reason for this is as follows. In the process of performing a heat treatment, under the influence of the difference in thermal expansion coefficient between the flexible member 6 and the base substrate 51, a stress is caused in the flexible member 6, thereby causing deflection. Since the difference in coefficient of thermal expansion directly affects the stress generated in one of the two materials in the surface where the two materials are in contact with each other, when the area where the two materials are in contact with each other is small, the resulting pressure becomes small and the amount of deflection tends to be reduced. In other words, by forming the groove 100, the area of the adhesive between the base substrate 51 and the flexible member 6 is reduced, and the residual stress is reduced. Further, when the stress is released, deflection is also caused in the groove 100 as with the space 7. Since the amount of the deflection at this time is determined by the residual stress, the generation of the deflection in the groove 100 reduces the deflection resulting in a convex shape toward the space 7 side, so that the flexible member 6 approaches a straight state. Thus, by reducing the deflection of the flexible member 6 in the unused state of the liquid ejection head substrate 1, the reduction of the absorption effect of the pressure fluctuation by the flexible member 6 is suppressed, and the deterioration of the controllability of ejection of the liquid ejection head substrate 1 is suppressed.

As described up to this point, according to the first embodiment, the formation of the groove 100 in the base substrate 51 reduces the deflection of the flexible member 6 which is deflected toward the space 7 side. The groove 100 is a depressed portion provided so as to depressed in the Z direction (first direction), which is the substrate stacking direction, in the bonding surface 51a of the base substrate 51. The groove 100 is provided in such a manner as to be blocked by the flexible member 6 at the position not overlapping the liquid flow passages 11 (the common flow passage 9 or the liquid feeding port 10) when viewed in the substrate stacking direction. That is, the region of the flexible member 6 which blocks the groove 100 is joined to the flow passage substrate 40 on the side thereof opposite to the side facing the groove 100. For this reason, it is configured such that the flexible member 6 is only allowed to be deflected and deformed to extend into the inside of the groove 100 in the substrate stacking direction. The depth of the groove 100 is the depth allowing the flexible member 6 to be deflected and deformed to extend into the inside of the groove 100, and is preferably the depth capable of allowing the flexible member 6 to be deformed to extend thereinto, for example, by 0.5 μm or more.

### Second Embodiment

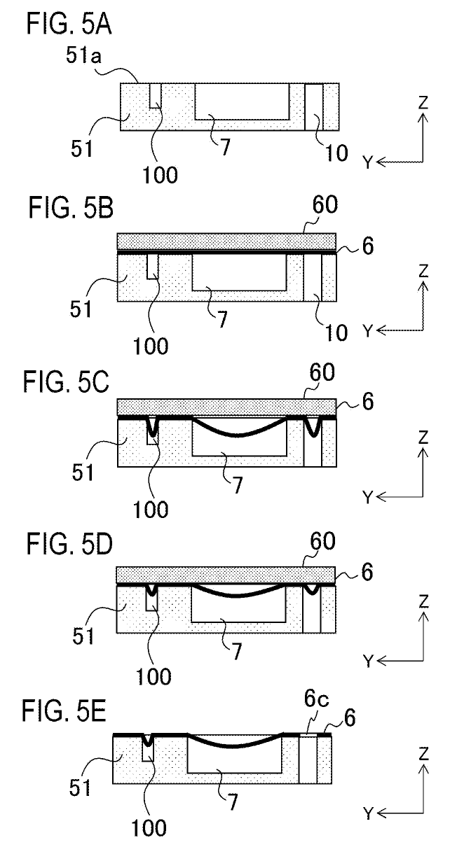

The compliance substrate 50 according to a second embodiment will be explained with reference to FIGS. 5A to 5D. It should be noted that, in the second embodiment, the same reference numerals and signs are assigned for the configurations common to the first embodiment and the comparative example, the repeated description thereof will be omitted, and differences from the first embodiment and the comparative example will be mainly described. Matters not particularly described in the second embodiment are the same as those in the first embodiment and the comparative example.

FIGS. 5A to 5D are each an illustrative diagram of a method for manufacturing the compliance substrate 50 according to the second embodiment. In the second embodiment, in addition to the base substrate 51 constituting the compliance substrate 50, using a support substrate 60, joining is performed in such a manner as to sandwich the flexible member 6 therebetween. Further, the groove 100 is formed in at least a part of the surface of the base substrate 51 which is joined to the support substrate 60 via the flexible member 6, and the flexible member 6 partially extends into the groove 100.

FIGS. 5A to 5E illustrate a method for manufacturing the compliance substrate 50 according to the first embodiment. FIG. 5A shows the state in which the groove 100 is formed on the base substrate 51 between the base substrate 51 and the flexible member 6 constituting the compliance substrate 50. FIG. 5B shows the state in which the flexible member 6 is fixed between the base substrate 51 and the support substrate 60. FIG. 5C shows the manner in which a heat treatment is performed in order to bond the flexible member 6 and the base substrate 51. FIG. 5D shows a state in which the flexible member 6 and the base substrate 51 are bonded to each other at normal temperature after the completion of the heat treatment. FIG. 5E shows the state in which the opening portion 6c is formed in the flexible member 6, with the support substrate 60 being removed. The opening portion 6c is to be joined to the flow passage substrate 40 later to serve as a liquid flow passage.

Similar to the first embodiment, as shown in FIG. 5C, the flexible member 6 undergoes deflection so as to be in a convex shape with respect to the space 7 by the heat treatment. At this time, the flexible member 6 is largely divided into two portions, namely, a portion where both sides thereof are sandwiched between the support substrate 60 and the base substrate 51, and a portion where one side thereof is opened as with the space 7 and the groove 100 of the base substrate. It can be seen that, regarding both side portions of the flexible member 6 sandwiched between the support substrate 60 and the base substrate 51, since the thermal conductivity is higher than that of the atmosphere, the reached temperature of the flexible member 6 is higher than that of the portions released on one side (that is, the portions facing the space 7 and the groove 100). For this reason, since the flexible member 6 cured by the heat treatment reaches the reached temperature at an earlier stage than in the first embodiment, the volume change becomes smaller, and the amount of deflection is reduced.. Thus, by reducing the deflection of the flexible member 6 in the unused state of the liquid ejection head substrate 1, the reduction of the absorption effect of the pressure fluctuation by the flexible member 6 is suppressed, and the deterioration of the controllability of ejection of the liquid ejection head substrate 1 is suppressed.

### Third Embodiment

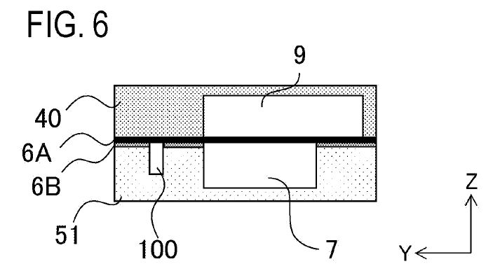

A configuration of the compliance substrate 50 according to a third embodiment will be explained with reference to FIG. 6. It should be noted that, in the third embodiment, the same reference numerals and signs are assigned for the configurations common to the first and second embodiments and the comparative example, the repeated description thereof will be omitted, and differences from the first and second embodiments and the comparative example will be mainly described. Matters not particularly described in the third embodiment are the same as those in the first and second embodiments.

FIG. 6 is a schematic cross sectional view of a layered structure formed by stacking a compliance substrate 50 and a flow passage substrate 40 according to the third embodiment. As shown in FIG. 6, the flexible member 6 may include two or more materials. As a result of this, the degree of freedom in molding is increased, and thus the materials closer to the thickness direction of the base substrate 51 are designated as a flexible member 6B and a flexible member 6A, respectively. By selecting appropriate materials for these, it is possible to more enhance the effect against the problems.

For example, the flexible member 6B is present on the junction surface to the base substrate 51, which plays a role of bonding the flexible member 6A to the base substrate 51. Also, the flexible member 6A mainly has a pressure suppressing effect, and when the thermally curing temperature of the flexible member 6B is lower than that of the flexible member 6A in the environment at the time of substrate bonding for the materials, the flexible member 6B, which has been in a convex shape with respect to the groove 100, is cured at a certain temperature, and keeps its expanded volume even after returning to ordinary temperature, and plays a role of fixing the flexible member 6A.

For the flexible member 6A and the flexible member 6B, epoxy, acrylic, urethane, silicone, benzocyclobutene, polyimide, polyamide, polyamideimide, cyanoacrylate, phenol, melamine, styrene, cyclic rubber, or a mixture thereof may be used. Among these materials, a resin including epoxy, silicone, benzocyclobutene, or polyimide, having excellent chemical resistance, as a main component is preferable.

### Fourth Embodiment

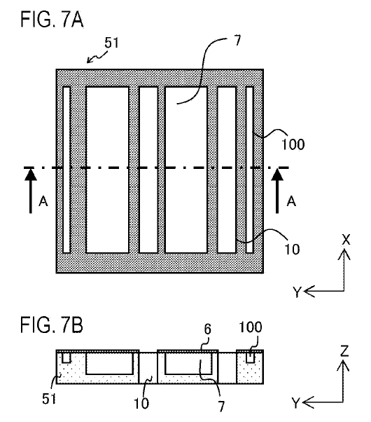

A configuration of the compliance substrate 50 according to a fourth embodiment will be explained with reference to FIGS. 7A and 7B. It should be noted that, in the fourth embodiment, the same reference numerals and signs are assigned for the configurations common to the first to third embodiments and the comparative example, the repeated description thereof will be omitted, and differences from the first to third embodiments and the comparative example will be mainly described. Matters not particularly described in the fourth embodiment are the same as those in the first to third embodiments.

FIG. 7A is a plan view of the base substrate 51 of the compliance substrate 50, and FIG. 7B is a cross sectional view taken along an arrow A of FIG. 7A. As shown in FIGS. 7A and 7B, the groove 100 may be formed between the end portion of the base substrate 51 and the space 7. That is, the groove 100 may be provided between the end portion of the base substrate 51 in the Y direction (second direction) orthogonal to the Z direction (first direction), which is the substrate stacking direction, and the space 7 serving as the damper chamber. Similarly, the groove 100 may be provided between the end portion of the base substrate 51 in the Y direction (second direction) and the liquid feeding port 10. Since the flexible member 6 directly above the space 7 is deformed by pressure fluctuations at the time of liquid ejection when the flexible member 6 is mounted as a liquid ejection head, a drawing force toward the center of the space 7 acts on the flexible member 6. At this time, since the area of the adhesive between the flexible member 6 and the base substrate 51 is reduced to reduce the deflection amount, it is preferable that a plurality of grooves 100 are formed on the flexible member junction surface in the vicinity of the outer periphery of the substrate.

In the present embodiment, the grooves 100 are formed in a form to extend in the X direction (third direction) orthogonal to both of the Z direction and the Y direction, and in parallel with the spaces 7 and the liquid feeding ports 10 in the vicinities of both ends of the base substrate 51 in the Y direction.

Incidentally, the shape of the groove 100 is not limited to a specific configuration, and may be any shape as long as it does not communicate with the space 7, the liquid feeding port 10, and the outside of the flow passage substrate. Further, when the grooves 100 are arranged at a position at which the joint area between the end portion of the base substrate 51 and the space 7 is large, an effect of suppressing the deflection of the flexible member 6 during a heat treatment at the time of joining between the flexible member 6 and the base substrate 51 is large. This arrangement is more preferable. Further, the greater the number of the grooves 100 that draw in the flexible member 6, the more area is ensured for the residual stress to be released. For this reason, the deflection of the flexible member 6 in the space 7 is relatively reduced. As a result of this, the reduction of the absorption effect of the pressure fluctuation by the flexible member 6 is suppressed, and the deterioration of the controllability of ejection of the liquid ejection head substrate 1 is suppressed.

### Fifth Embodiment

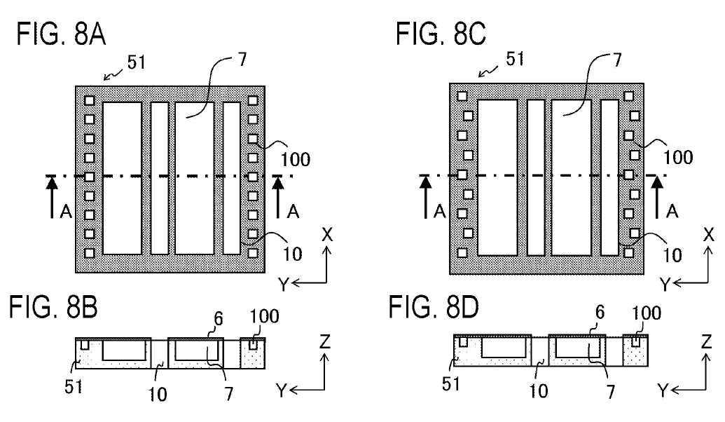

A configuration of the compliance substrate 50 according to a fifth embodiment will be explained with reference to FIGS. 8A to 8D. It should be noted that, in the fifth embodiment, the same reference numerals and signs are assigned for the configurations common to the first to fourth embodiments and the comparative example, the repeated description thereof will be omitted, and differences from the first to fourth embodiments and the comparative example will be mainly described. Matters not particularly described in the fifth embodiment are the same as those in the first to fourth embodiments, and the comparative example.

FIG. 8A is a plan view of the base substrate 51 of the compliance substrate 50 of the fifth embodiment, and FIG. 8B is a cross sectional view taken along an arrow A of FIG. 8A. FIG. 8C is a plan view of the base substrate 51 of the compliance substrate 50 of another example of the fifth embodiment, and FIG. 8D is a cross sectional view taken along an arrow A of FIG. 8C. As shown in FIGS. 8A to 8D, the grooves 100 assume appropriate shape and arrangement in the base substrate 51. As a result, it is possible to define the drawing amount of the flexible member 6, and to control the amount of deflection of the flexible member 6 in the space 7.

FIGS. 8A and 8B each show a compliance substrate 50 having a plurality of grooves in the same shape formed on the outer periphery of the space 7. In the configuration example of the present embodiment shown in FIGS. 8A and 8B, it is configured such that the plurality of grooves 100 are arranged at intervals in the X direction in the vicinities of both ends of the base substrate 51 in the Y direction (i.e., a configuration in which an array is formed in the X direction). In the present configuration example, the plurality of grooves 100 respectively have the same size, and the adjacent grooves 100 are aligned in the X direction at equal intervals. The individual grooves 100 are configured in a substantially rectangular shape in a plan view, and one side of the rectangular opening edge may be formed with, for example, 10 μm to 200 μm.

The flexible member 6 is drawn into the center of the space 7 due to the pressure fluctuations generated at the time of liquid ejection, thereby generating deflection, and the deflection is reduced by the grooves 100 provided in the vicinity of the space 7. Further, the amount of deflection of the flexible member 6 which is drawn into the grooves 100 at this time is determined by the joint area between the flexible member 6 and the base substrate 51 in the vicinity of the groove 100, and the residual stress increases with an increase in this area, and the deflection amount is also increased. Further, even when the planar dimension of the groove 100 is large, it is possible to draw a larger portion of flexible members 6. For this reason, this configuration is effective for suppressing the deflection of the space 7.

FIGS. 8C and 8D each show the compliance substrate 50 having a plurality of grooves arranged in a zigzag form on the outer periphery of the space 7. In the configuration example of the present embodiment shown in FIGS. 8C and 8D, it is configured such that the plurality of grooves 100 are arrayed at intervals in the X direction in the vicinities of both ends of the base substrate 51 in the Y direction, and the grooves 100 which are adjacent to each other in the X direction are arrayed so as to be shifted from each other in the Y direction. In the present configuration example, the plurality of grooves 100 respectively have the same size, and the grooves 100 adjacent to each other in the X direction are arrayed in the X direction at equal intervals, and the amounts of shift in the Y direction between the grooves 100 adjacent to each other in the X direction are unified.

When the flexible member 6 is deflected into the space 7, the amount of deflection is generally reduced from the center toward the outside. For this reason, the uniform arrangement locations of the grooves 100 with respect to the periphery of the space 7 results in a uniform reduction of the deflection amount in the space 7. In other words, the grooves 100 are more effective when the junction area between the flexible member 6 and the base substrate 51 is uniform. Therefore, as shown in FIGS. 8C and 8D, the amount of deflection is more preferably controlled by the grooves 100 arranged in a zigzag form.

### Sixth Embodiment

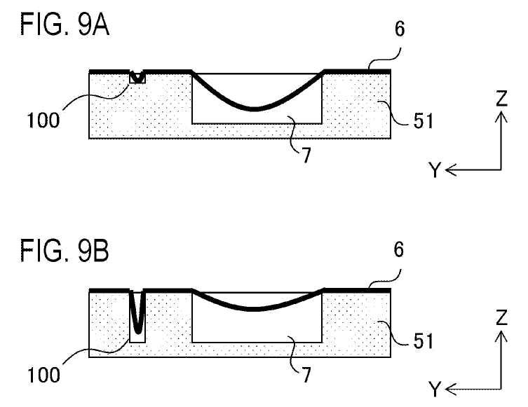

A configuration of the compliance substrate 50 according to a sixth embodiment will be explained with reference to FIGS. 9A and 9B. It should be noted that, in the sixth embodiment, the same reference numerals and signs are assigned for the configurations common to the first to fifth embodiments and the comparative example, the repeated description thereof will be omitted, and differences from the first to fifth embodiments and the comparative example will be mainly described. Matters not particularly described in the sixth embodiment are the same as those in the first to fifth embodiments.

FIG. 9A is a view showing an example of the configuration in which the depth in the thickness direction (Z direction) of the groove 100 is not sufficient. FIG. 9B is a view showing an example of the configuration in which the depth in the thickness direction of the groove 100 is sufficient. In the configuration example shown in FIG. 9A, since the depth of the groove 100 is not sufficient (the flexible member 6 may come in contact with the bottom surface of the groove 100 depending on the amount of deflection), the volume of the flexible member 6 extending into the inside of the groove 100 is reduced, and the saturated flexible member 6 is pushed out so as to be in a convex shape with respect to the space 7. As a result, the amount of deflection of the flexible member 6 in the upper portion of the space 7 increases, the damping performance when the flexible member 6 is mounted on the liquid ejection head becomes insufficient, the absorbing effect of pressure fluctuations by the flexible member 6 deteriorates, and the controllability of ejection of the liquid ejection head substrate 1 deteriorates.

On the other hand, in the configuration example shown in FIG. 9B, the groove 100 has a sufficient depth in the thickness direction. The depth of the groove 100 may be set such that, for example, the flexible member 6 deflected in the groove 100 does not come in contact with the bottom surface of the groove 100, regardless of the degree of the deflection amount thereof. Therefore, the allowable amount of the flexible member 6 extending into the inside of the groove 100 becomes large, and the flexible member 6 deformed by the heat treatment is filled in the groove 100, so that the amount of deflection of the flexible member 6 in the upper portion of the space 7 becomes relatively smaller. Thus, by reducing the deflection of the flexible member 6 in the unused state of the liquid ejection head substrate 1, the reduction of the absorption effect of the pressure fluctuations by the flexible member 6 is suppressed, and the deterioration of the controllability of ejection of the liquid ejection head substrate 1 is suppressed.

### Seventh Embodiment

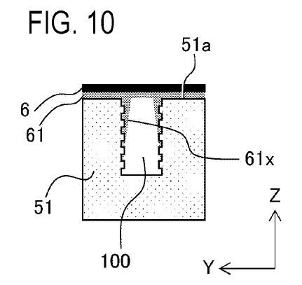

A method for manufacturing a compliance substrate 50 according to a seventh embodiment will be described with reference to FIG. 10. It should be noted that, in the seventh embodiment, the same reference numerals and signs are assigned for the configurations common to the first to sixth embodiments and the comparative example, the repeated description thereof will be omitted, and differences from the first to sixth embodiments and the comparative example will be mainly described. Matters not particularly described in the seventh embodiment are the same as those in the first to sixth embodiments.

First, a resist pattern was drawn on a silicon substrate by photolithography, and then dry etching was performed to form the space 7, a liquid feeding port 10, and a groove 100, thus manufacturing a base substrate 51. Then, an adhesive 61 which was a thermosetting resin mainly including an organic resin was applied to the bonding surface 51a of the base substrate 51 having the space 7 formed therein, and a flexible member 6 which is a polyimide film having a thickness of 3 μm was bonded to the bonding surface 51a. Next, a 200°C heat treatment was performed, thereby curing the adhesive 61. As a result, the flexible member 6 was fixed to the base substrate 51. A part 61x of the adhesive 61 which extended into the groove 100 at that time was more drawn into the bottom of the groove 100 along the unevenness of the inner walls (side walls) of the groove 100, and was thereafter thermally cured, thereby adhering more strongly. As a result of this, the adhesive 61 is firmly fixed in the groove 100, and the amount of deflection thereof with respect to the groove 100 does not change permanently. As a result of this, not only the amount of deflection of the flexible member 6 directly above the space 7 is suppressed, but also it becomes possible to keep the state.

Next, regarding some of the above embodiments, the configuration of the liquid ejection head substrate 1 actually manufactured and the ejection evaluation using the liquid ejection head substrate 1 will be described.

### Example 1

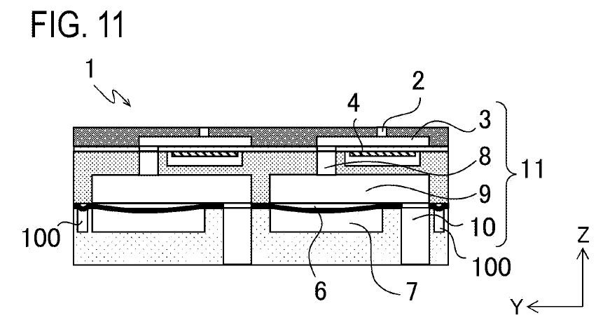

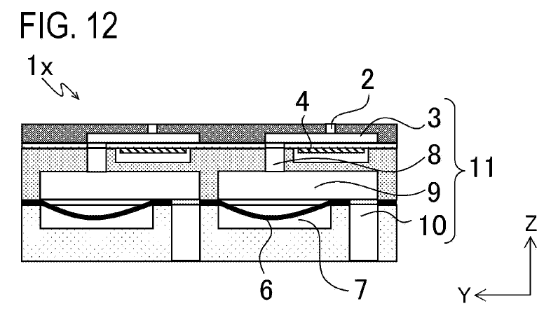

Example 1 will be described with reference to FIGS. 11 and 12. FIG. 11 is a schematic cross sectional diagram of the liquid ejection head substrate 1 according to Example 1. As with the first embodiment, Example 1 shows the compliance substrate 50 provided with the groove 100 into which a part of the flexible member 6 extends in the base substrate 51. FIG. 12 is a schematic cross sectional diagram of the liquid ejection head substrate 1x according to a comparative example. In the comparative example, no groove 100 is provided.

In Example 1, a silicon substrate was used as the base substrate 51 of the compliance substrate 50, and a polyimide film was used as the flexible member 6. In Example 1, the thermal expansion coefficient of the base substrate 51 which is a silicon substrate is approximately less than 5 ppm/K, and the thermal expansion coefficient of the flexible member 6 which is a polyimide film is approximately 10 to 50 ppm/K.

For manufacturing of the liquid ejection head substrate 1 according to Example 1, a resist pattern was first drawn on a silicon substrate by photolithography, and then dry etching was performed, thereby forming the space 7, the liquid feeding port 10, and the grooves 100. As a result, the base substrate 51 was manufactured. At this step, a plurality of grooves 100 were formed between the space 7 and the end portion of the base substrate 51 in such a manner that each is in a square shape with a length per side of 50 μm in the horizontal direction and has a depth of 225 μm in the thickness direction of the base substrate 51.

Then, the adhesive 61 mainly including an organic resin was applied to the bonding surface 51a of the base substrate 51 with the space 7 formed therein, and a polyimide film having a thickness of 3 μm was bonded to the bonding surface 51a. Next, a 250°C heat treatment was carried out, thereby curing the adhesive 61, so that the flexible member 6, which is a polyimide film, was fixed to the base substrate 51. The contact angle of adhesive 61 at this step was 2°, and it was confirmed that the adhesive 61 crept up along the inner walls of the grooves 100.

After the adhesive 61 was fixed (cured), the flexible member 6 which is a polyimide film was deflected and extended by about 1.5 μm toward the space 7 side, and by about 0.5 μm toward the groove 100 side.

After the flexible member 6 which is a polyimide film was bonded to the base substrate 51, pattern formation by a photoresist and etching processing were carried out in order to remove the polyimide film at a portion corresponding to the liquid feeding port 10, so that the liquid feeding port 10 was penetrated. As a result, the compliance substrate 50 was manufactured. Thereafter, a nozzle substrate 20, a pressure generating substrate 30, and a flow passage substrate 40, which had been separately prepared, were joined to each other, thereby manufacturing the liquid ejection head substrate 1.

The method for manufacturing a liquid ejection head substrate 1x of the comparative example is the same as that of Example 1 except that the grooves 100 are not formed. Therefore, as shown in FIG. 12, in the liquid ejection head substrate 1x of the comparative example, the groove 100 is not formed on the surface of the flexible member 6 or the base substrate 51. In addition, the amount of deflection of the flexible member 6 toward the space 7 side of the flexible member 6 in the state in which the pressure generation unit 4 in the configuration of the comparative example does not generate a pressure is larger than that of the liquid ejection head substrate 1 in Example 1.

Ejection evaluation was performed using the liquid ejection head substrate 1 of Example 1 manufactured as described above and the liquid ejection head substrate 1x of the comparative example. In the ejection evaluation, liquid was ejected using the respective substrates for a liquid ejection head 1 and 1x, and the behavior was observed. In the liquid ejection head substrate 1x according to the comparative example, there were caused changes in the flying speed and volume of the liquid, which are considered to be crosstalk between the nozzles 2 adjacent to each other. On the other hand, in the liquid ejection head substrate 1 in accordance with Example 1, crosstalk did not occur under the same driving conditions, and an improvement of the effect of suppressing the pressure fluctuations by the flexible member 6 was observed.

The configurations of the embodiments and the respective modification examples described above can be combined with each other.

According to the present disclosure, it is possible to stabilize the liquid ejection performance of a liquid ejection head.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-076387, filed May. 1, 2025, which is hereby incorporated by reference herein in its entirety.

What is claimed is:

1. A liquid ejection head substrate , the substate comprising:
a pressure chamber provided with an ejection port for ejecting liquid;
a pressure generation unit configured to generate a pressure inside of the pressure chamber to eject liquid from the ejection port;
a liquid feeding port configured to receive a supply of liquid;
a liquid flow passage configured to guide liquid from the liquid feeding port to the pressure chamber;
a flexible member that constitutes a portion of an inner wall surface of the liquid flow passage; and
a damper chamber forming a space allowing deformation of the flexible member, the space being separated from the liquid flow passage by the flexible member, wherein
the liquid ejection head substrate includes:
a base substrate having the liquid feeding port penetrating in a first direction therethrough, and having the damper chamber provided on a bonding surface that is one surface in the first direction so as to be depressed in the first direction, and having the flexible member bonded thereto so as not to block the liquid feeding port and so as to block the damper chamber; and
a flow passage substrate having a flow passage forming portion that communicates with the liquid feeding port to form a portion of the liquid flow passage, the flow passage substrate being stacked relative to the base substrate via the flexible member in the first direction,
the base substrate having a depressed portion provided so as to be depressed in the first direction at the bonding surface, and the depressed portion being at a position not overlapping the liquid flow passage as viewed in the first direction, and being blocked by the flexible member.

2. The liquid ejection head substrate according to claim 1, wherein
the flexible member is deflected in such a manner as to extend into an inside of the damper chamber and is deflected so as to extend into an inside of the depressed portion.

3. The liquid ejection head substrate according to claim 1, wherein
the depressed portion has a depth that allows deformation of the flexible member.

4. The liquid ejection head substrate according to claim 1, wherein
the flexible member extends into an inside of the depressed portion by at least 0.5 μm in the first direction.

5. The liquid ejection head substrate according to claim 1, wherein
the depressed portion is provided between an end portion of the base substrate in a second direction orthogonal to the first direction and the damper chamber.

6. The liquid ejection head substrate according to claim 1, wherein
the depressed portion is provided between an end portion of the base substrate in a second direction orthogonal to the first direction and the liquid feeding port.

7. The liquid ejection head substrate according to claim 5, wherein
the depressed portion extends along a third direction that is orthogonal to both of the first direction and the second direction.

8. The liquid ejection head substrate according to claim 7, wherein
the depressed portion is provided in plurality and arrayed at intervals along the third direction.

9. The liquid ejection head substrate according to claim 8, wherein
the depressed portion is provided in plurality in a zigzag form, in which the adjacent depressed portions are shifted from each other in the second direction.

10. The liquid ejection head substrate according to claim 8, wherein
the depressed portion has a rectangular shape as viewed in the first direction.

11. The liquid ejection head substrate according to claim 10, wherein
one side of an opening edge of the rectangular shape in the depressed portion is 10 μm to 200 μm.

12. The liquid ejection head substrate according to claim 1, wherein
the depressed portion has unevenness on an inner wall surface, and
the flexible member has a portion that is in contact with the unevenness.

13. The liquid ejection head substrate according to claim 1, wherein
the depressed portion is configured so as to generate deflection of the flexible member extending into an inside of the depressed portion in order to reduce deflection of the flexible member extending into an inside of the damper chamber in a state in which the pressure generation unit is not generating the pressure.

14. The liquid ejection head substrate according to claim 1, wherein
the flexible member is bonded to the bonding surface via an adhesive, and
the adhesive is a thermosetting resin and is cured at a temperature lower than a curing temperature of the flexible member.

15. A method for manufacturing a liquid ejection head substrate , the liquid ejection head substrate including:
a pressure chamber provided with an ejection port for ejecting liquid;
a pressure generation unit configured to generate a pressure inside of the pressure chamber to eject liquid from the ejection port;
a liquid feeding port configured to receive a supply of liquid;
a liquid flow passage configured to guide liquid from the liquid feeding port to the pressure chamber;
a flexible member that constitutes a portion of an inner wall surface of the liquid flow passage;
a damper chamber forming a space allowing deformation of the flexible member, the space being separated from the liquid flow passage by the flexible member;
a base substrate having the liquid feeding port penetrating in a first direction therethrough, and having the damper chamber provided on a bonding surface that is one surface in the first direction so as to be depressed in the first direction, and having the flexible member bonded thereto so as not to block the liquid feeding port and so as to block the damper chamber; and
a flow passage substrate having a flow passage forming portion that communicates with the liquid feeding port to form a portion of the liquid flow passage, the flow passage substrate being stacked relative to the base substrate via the flexible member in the first direction, the method for manufacturing the liquid ejection head substrate comprising:
forming a depressed portion that is depressed in the first direction at a position not overlapping the liquid flow passage as viewed in the first direction and blocked by the flexible member in the bonding surface of the base substrate;
bonding the flexible member to the base substrate;
joining the flow passage substrate and the base substrate such that the damper chamber and the depressed portion are separated from each other by the flexible member; and
curing the flexible member by a heat treatment, wherein
by the heat treatment, the flexible member is deflected such that a portion of the flexible member extends into an inside of the depressed portion.
